(19) United States
(12) Patent Application Publication
(10) Pub. No.: US 2011/0059235 A1
(43) Pub. Date: Mar. 10, 2011

(54) METHOD FOR PRODUCING MAGNETIC RECORDING MEDIUM AND PRODUCING APPARATUS THEREOF

(75) Inventors: Masato FUKUSHIMA, Chiba-shi (JP); Shinichi ISHIBASHI, Tokyo (JP); Akira YAMANE, Ichihara-shi (JP)

(73) Assignee: SHOWA DENKO K.K., Tokyo (JP)

(21) Appl. No.: 12/611,182

(22) Filed: Nov. 3, 2009

(30) Foreign Application Priority Data
Nov. 7, 2008 (JP) P2008-286467

(51) Int. Cl. B05D 5/00; B05C 13/00

(52) U.S. Cl. 427/128; 118/500

(57) ABSTRACT

Provided are a method of producing a magnetic recording medium with improved environmental resistance, especially, corrosion resistance and an apparatus used therefor. In producing a magnetic recording medium having a magnetic recording pattern on a magnetic recording layer formed on at least a surface of a nonmagnetic substrate using an in-line film formation apparatus, the method comprising: mounting a nonmagnetic substrate on the carrier, the nonmagnetic substrate having at least the magnetic recording layer and a mask layer corresponding to the magnetic recording pattern laminated thereon in this order; forming the magnetic recording pattern by having areas of the magnetic recording layer that are not covered with the mask layer subjected to a reactive plasma treatment or an ion irradiation treatment; removing the mask layer from the magnetic recording layer; and removing the nonmagnetic substrate from the carrier, wherein each of the chambers has a decompressed atmosphere inside while the carrier passes through each of the chambers and each of the processes are conducted continuously while being blocked from the ambient air.

### BACKGROUND OF THE INVENTION

1. Field of the Invention

The present invention relates to a method of producing a magnetic recording medium used for a hard disk device and to an apparatus used therefor. More particularly, the invention relates to a method of producing, for example, a discrete track medium and a patterned medium which has a magnetically-isolated magnetic recording area, and to an apparatus for implementing the method.

Priority is claimed on Japanese Patent Application No. 2008-286467, filed Nov. 7, 2008, the content of which is incorporated herein by reference.

2. Background Art

In recent years, magnetic recorders such as magnetic disk units, flexible disk units, and magnetic tape units have been used over a remarkably wider range of applications, and play more important roles. With this trend, an attempt is being made to highly increase the recording density of magnetic recording media for use in such recorders. In particular, the surface recording density has been vigorously increasing since the introduction of an MR head and PRML technology. Moreover, since a GMR head and a TuMR head have also been introduced in recent years, the surface recording density keeps increasing at a rate as high as about 100% per year.

Regarding these magnetic recording media, there is a demand for a further increase of the recording density in the future. It is therefore necessary to increase the coercive force, the signal-to-noise ratio (SNR) and the resolution of the magnetic layer. In recent years, efforts to increase the surface recording density have been made by increasing the track density simultaneously with increasing the linear recording density.

The most recent magnetic recording media have a track density of as high as 110 kTPI. As the track density increases, however, magnetic recording information between adjacent tracks begins interfering with each other. As a result, a magnetizing transition area of a border area becomes a noise source, which may easily decrease the SNR. The decrease in the SNR may directly lead to a decrease in a bit error rate and prevent an improvement in recording density.

In order to increase the surface recording density, it is necessary to make the size of each recording bit on the magnetic recording medium finer and to secure the biggest possible saturation magnetization and the magnetic film thickness to each recording bit. However, as the recording bit becomes finer, the magnetizing minimum volume per 1 bit becomes small and recorded data may disappear by magnetization reversal caused by heat fluctuation.

As the track density increases, since the adjacent tracks come close to each other, a very highly precise track servo technique is necessary for the magnetic recording device. Usually, information is recorded on a wide track and reproduced in a narrower track in order to avoid influence from adjacent tracks to the minimum. Although influence between the tracks can be suppressed to the minimum by this method, however, it is difficult to obtain a sufficient reproduction output and it is thus difficult to provide a sufficient SNR.

In order to recognize the problems of the heat fluctuation and reliability of the SNR or to provide sufficient outputs, unevenness along the track is formed on the surface of the recording medium so as to isolate the recording tracks physically from one another to increase the track density. Such a technique is usually called a discrete track method and a magnetic recording medium produced thereby will be called a discrete track medium. An attempt has also been made to provide a “patterned medium” which has further divided data areas in a track.

An exemplary discrete track medium is a magnetic recording medium which is formed on a non-magnetic substrate having an uneven pattern formed thereon and a physically-isolated magnetic recording track and a servo signal pattern are formed on the medium (for example, see Japanese Unexamined Patent Application, First Publication No. 2004-164692).

In the disclosed magnetic recording medium, a ferromagnetic layer is formed via a soft magnetic layer on the substrate surface with plural unevenness thereon. A protective film is formed on the surface of the ferromagnetic layer. In this magnetic recording medium, a physically-isolated magnetic recording area is formed around a projecting area.

According to the disclosed magnetic recording medium, generation of a magnetic wall on the soft magnetic layer can be avoided, and the influence of the heat fluctuation can thus be made small and no interference occurs between adjacent signals. As a result, a high-density magnetic recording medium with less noise can be provided.

The discrete track method includes a method of forming a track after a magnetic recording medium consisting of several layers of thin films are formed, and a method of forming an uneven pattern on a substrate surface directly or on a thin film layer for track formation, and then forming a thin film of a magnetic recording medium (for example, see Japanese Unexamined Patent Application, First Publication Nos. 2004-178793 and 2004-178794).

As another approach, a method of forming an area between magnetic tracks of a discrete track medium by injecting nitrogen ions and oxygen ions or the like into a previously formed magnetic layer or by irradiating with laser so as to change magnetic characteristics in that area is disclosed (for example, see Japanese Unexamined Patent Application, First Publication Nos. 5-205257, 2006-209952 and 2006-309841).

The discrete track medium can be produced in, for example, the following manner: a soft magnetic layer, an intermediate layer and a magnetic recording layer or the like are formed on a nonmagnetic substrate; a mask layer is formed on the surface of magnetic recording layer in order for forming a magnetic recording area using a photolithography technology; the magnetic recording layer is exposed to, for example, reactive plasma so that the magnetic property in areas not covered with the mask layer are reformed; the mask layer is removed; and a protective layer and a lubricant film are formed on the magnetic recording layer.

In this method, it is preferable to perform these processes continuously in a single film formation apparatus. This is because the substrate contamination during handling can be prevented, the manufacturing process can be made efficient with fewer handling processes or the like and the product yield can be increased to improve productivity of the magnetic recording medium.

Regarding such a method of manufacturing a discrete track medium, the use of an in-line film formation apparatus has been proposed (for example, see Japanese Unexamined Patent Application, First Publication No. H8-274142). In the disclosed method, a carrier which holds several nonmagnetic substrates thereon is sequentially conveyed among a plurality of chambers. In the course of conveyance, a soft magnetic layer, an intermediate layer, a magnetic recording layer and a protective layer are sequentially deposited at both sides of these nonmagnetic substrates.

In manufacturing a discrete track medium using the above in-line film formation apparatus, a magnetic recording layer is first deposited on a substrate, a mask layer is formed on a surface of the magnetic recording layer and the magnetic recording layer is subjected to a reactive plasma treatment or an ion irradiation treatment. In this manner, the magnetic property of the magnetic recording layer in the areas not covered with the mask layer is reformed to provide a magnetic recording pattern formed by the remaining magnetic material.

According to the study of the present inventors, however, a discrete track medium produced by the in-line film formation apparatus described above is inferior in environmental resistance, especially corrosion resistance compared with an ordinary magnetic recording medium with no patterned magnetic layer.

### SUMMARY OF THE INVENTION

The invention provides a method of producing a magnetic recording medium with improved environmental resistance, especially, corrosion resistance and an apparatus used therefore, when the magnetic recording medium having a magnetic recording pattern on at least a magnetic recording layer formed on a surface of a nonmagnetic substrate is produced using an in-line film formation apparatus.

### BRIEF DESCRIPTION OF THE DRAWINGS

FIG. 1 is a cross-sectional view of an exemplary magnetic recording medium to which the invention is applied.

FIG. 2 is a cross-sectional view of another exemplary magnetic recording medium to which the invention is applied.

FIG. 3 is a cross-sectional view of an exemplary magnetic recording and reproducing apparatus.

FIG. 4 is a plan view of a configuration of an in-line film formation apparatus to which the invention is applied.

FIG. 5 is a side view of a career of the in-line film formation apparatus to which the invention is applied.

FIG. 6 is a side view of a main part of the in-line film formation apparatus to which the invention is applied.

FIG. 7 is a cross-sectional view of the main part of the in-line film formation apparatus to which the invention is applied.

FIG. 8 is a schematic cross-sectional view illustrating a method of producing the magnetic recording medium illustrated in a process sequence according to an embodiment of the invention.

FIG. 9 is a schematic cross-sectional view of a method of producing the magnetic recording medium illustrated in a process sequence according to an embodiment of the invention.

FIG. 10 is a schematic cross-sectional view of a method of producing the magnetic recording medium illustrated in a process sequence according to an embodiment of the invention.

FIG. 11 is a schematic cross-sectional view of a method of producing the magnetic recording medium illustrated in a process sequence according to an embodiment of the invention.

FIG. 12 is a schematic cross-sectional view of a method of producing the magnetic recording medium illustrated in a process sequence according to an embodiment of the invention.

FIG. 13 is a schematic cross-sectional view of a method of producing the magnetic recording medium illustrated in a process sequence according to an embodiment of the invention.

FIG. 14 is a schematic cross-sectional view of a method of producing the magnetic recording medium illustrated in a process sequence according to an embodiment of the invention.

FIG. 15 is a schematic cross-sectional view of a method of producing the magnetic recording medium illustrated in a process sequence according to an embodiment of the invention.

FIG. 16 is a schematic cross-sectional view of a method of producing the magnetic recording medium illustrated in a process sequence according to an embodiment of the invention.

### BRIEF DESCRIPTION OF THE REFERENCE SYMBOLS

1: Substrate cassette transfer robot platform
2: Substrate supplying robot chamber
3: Substrate cassette transfer robot
4, 7, 14, 17: Corner chambers
5, 6, 8 to 13, 15, 16, 18 to 21: Chambers
22: Substrate removing robot chamber
23: First substrate for film formation
24: Second substrate for film formation
25: Carrier
26: Support platform
27: Holder
28: Plate body
29: Circular opening
30: Supporting member
34: Substrate mounting robot (substrate mounting mechanism)
49: Substrate removing robot (substrate removal mechanism)
52: Substrate mounting chamber
53: Substrate removal chamber
55 to 72: Gate valves
80: Nonmagnetic substrate
81: Soft magnetic layer
82: Intermediate layer
83: Magnetic recording layer
83a: Magnetic recording patterns
83b: Nonmagnetic areas
84: Protective layer
85: Lubricating film
810: Magnetic layer
840: Mask layer
850: Resist layer
91: Chamber
92: Processing device
201: Driving mechanism (conveyance mechanism)
202: Magnet
203: Rotating magnet
204: Vacuum partition
205: Rotary motor
206: Rotation axis

### PREFERRED EMBODIMENTS

The present inventors have intensively studied studying these problems and found that corrosion of the magnetic recording medium occurs in the following mechanism. Areas of the magnetic recording layer, which formed on the nonmagnetic substrate are not covered with the mask layer, are subjected to a reactive plasma treatment or an ion irradiation treatment so as to form a magnetic recording pattern. The mask layer is then removed from the magnetic recording layer. During this process, a surface of the magnetic recording layer is activated. When the activated surface of the magnetic recording layer is brought into contact with the ambient air, the surface is readily oxidized and oxides developed on the surface may cause corrosion of the magnetic recording medium.

The study of the present inventors also reveals that, especially if dry etching using halogen is performed in the process described above, a halide, such as a cobalt halide, is formed on the activated surface of the magnetic recording layer and when the halide is brought into contact with the ambient air, the halide may cause rapid corrosion of the magnetic recording medium.

From the result of the above study, the present inventors have found that a magnetic recording medium with excellent environmental resistance can be obtained by conducting the above-described processes continuously without exposing the nonmagnetic substrate to the ambient air, and especially by conducting the processes under halogen gas-free environment and have finally completed the invention.

The invention provides a method of producing a magnetic recording medium and an apparatus used therefor, which will be described below.

(1) A method of producing a magnetic recording medium which has a magnetic recording pattern on a magnetic recording layer formed at least on a surface of a nonmagnetic substrate by using an in-line film formation apparatus that includes a plurality of chambers, a carrier which holds a nonmagnetic substrate through the plurality of chambers and a conveyance mechanism which conveys the carrier sequentially among the plurality of chambers, which comprises the steps of: mounting a nonmagnetic substrate on the carrier, the nonmagnetic substrate having at least the magnetic recording layer and a mask layer corresponding to the magnetic recording pattern laminated thereon in this order; forming the magnetic recording pattern by having areas of the magnetic recording layer that are not covered with the mask layer subjected to a reactive plasma treatment or an ion irradiation treatment; removing the mask layer from the magnetic recording layer; and removing the nonmagnetic substrate from the carrier, wherein each of the chambers has a decompressed atmosphere inside while the carrier passes through each of the chambers and each of the processes are conducted continuously while being blocked from the ambient air.

(2) The method of producing a magnetic recording medium according to above (1), wherein each of the processes is conducted under a halogen gas-free atmosphere.

(3) A apparatus for producing a magnetic recording medium, which comprises: a plurality of chambers; a carrier which holds a nonmagnetic substrate through the plurality of chambers; and a conveyance mechanism which conveys the carrier sequentially among the plurality of chambers, the apparatus being used to produce a magnetic recording medium which has a magnetic recording pattern on a magnetic recording layer formed at least on a surface of a nonmagnetic substrate, wherein the plurality of chambers include: a chamber equipped with a substrate mounting mechanism which mounts a nonmagnetic substrate on the carrier, the nonmagnetic substrate having at least the magnetic recording layer and a mask layer corresponding to the magnetic recording pattern laminated thereon in this order; a chamber in which the magnetic recording pattern is formed by having areas of the magnetic recording layer that are not covered with the mask layer subjected to a reactive plasma treatment or an ion irradiation treatment; a chamber in which the mask layer is removed from the magnetic recording layer; and a chamber equipped with a substrate removal mechanism which removes the nonmagnetic substrate from the carrier, wherein each of the chambers has a decompressed atmosphere inside while the carrier passes through each of the chambers and is blocked from the ambient air.

### EFFECTS OF THE INVENTION

As described above, according to the invention, it is possible to produce a magnetic recording medium with improved environmental resistance, especially, corrosion resistance in a following manner: when the magnetic recording medium having a magnetic recording pattern formed at least on a magnetic recording layer formed on a surface of the nonmagnetic substrate is produced using an in-line film formation apparatus, each of the chambers has a decompressed atmosphere inside and each of the processes are conducted continuously while being blocked from the ambient air, especially being under a halogen gas-free atmosphere.

Referring now to the drawings, embodiments of the invention will be described in detail. In the present embodiment, an exemplary method of producing a magnetic recording medium incorporated in a hard disk device by using an in-line film formation apparatus which performs a film formation process while sequentially conveying a nonmagnetic substrate to be subject to film formation through a plurality of chambers will be described.

### (Magnetic Recording Medium)

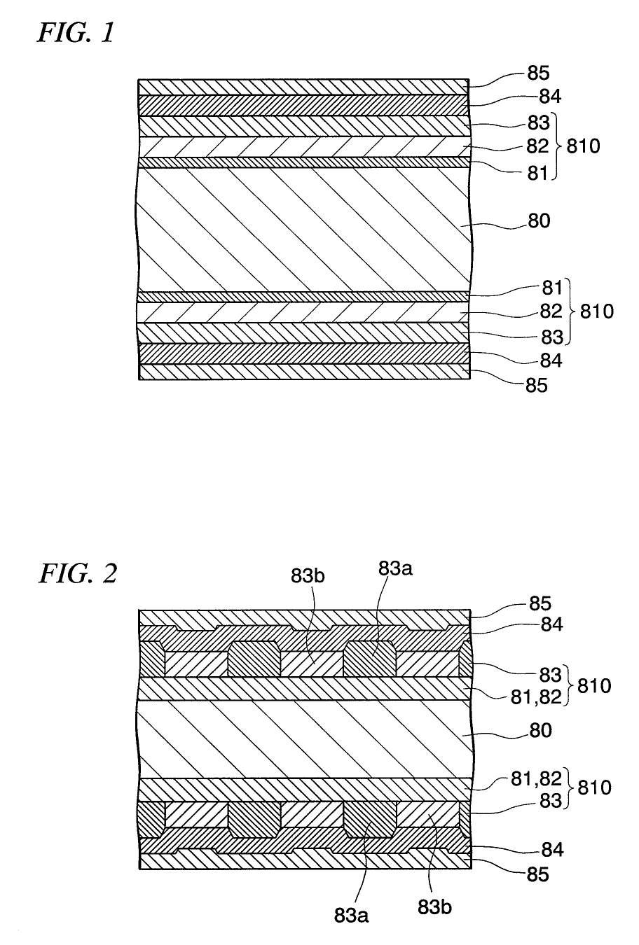

As illustrated, for example in FIG. 1, a magnetic recording medium produced in accordance with the invention is configured so that a soft magnetic layer 81, an intermediate layer 82, a magnetic recording layer 83 and a protective layer 84 are laminated in this order on both sides of a nonmagnetic substrate 80. A lubricating film 85 is formed on an outermost surface of the laminated structure. The soft magnetic layer 81, the intermediate layer 82 and the magnetic recording layer 83 altogether constitutes a magnetic layer 810.

The non-magnetic substrate 80 may be any substrate so long as it is a non-magnetic substrate. Examples thereof include an Al alloy substrate, such as Al—Mg alloy, having Al as a principle component, and usual substrates made of soda glass, aluminosilicate-based glass, crystallized glasses, silicon, titanium, ceramic and various type of resins.

Among these, an Al alloy substrate, glass substrates, such as crystallized glass or the like, or silicon substrates are preferably used. The average surface roughness (Ra) of these substrates is preferably not more than 1 nm, more preferably not more than 0.5 nm and especially preferably not more than 0.1 nm.

An in-plane magnetic layer for an in-plane magnetic recording medium or a perpendicular magnetic layer for a perpendicular magnetic recording media can be used as the magnetic layer 810. The perpendicular magnetic layer is especially preferable from the viewpoint of high recording density. The magnetic layer 810 is preferably produced by Co-based alloy. As a magnetic layer 810 for a perpendicular magnetic recording medium, for example, a lamination structure composed of a soft magnetic layer 81, an intermediate layer 82 and a magnetic recording layer 83. Examples of the soft magnetic layer 81 include FeCo alloy (e.g., FeCoB, FeCoSiB, FeCoZr FeCoZrB and FeCoZrBCu), FeTa alloy (e.g., FeTaN and FeTaC) and Co alloy (e.g., CoTaZr, CoZrNB and CoB), which have a soft magnetic property. The intermediate layer 82 may include Ru. The magnetic recording layer 83 may include 60Co-15Cr-15 Pt alloy and 70Co-5Cr-15Pt-10SiO₂ alloy. An orientation controlling film including Pt, Pd, NiCr and NiFeCr etc., may be laminated between the soft magnetic layer 81 and the intermediate layer 82. As a magnetic layer 810 for an in-plane magnetic recording medium, for example, a lamination structure composed of a non-magnetic CrMo underlayer and a ferromagnetic CoCrPtTa magnetic layer can be used.

The thickness of the magnetic layer 810 is not less than 3 nm to not more than 20 nm and preferably not less than 5 nm to not more than 15 nm. It suffices that the magnetic layer 810 is formed to provide sufficient input and output performance of the head in accordance with the type and the lamination structure of the magnetic alloy used. The thickness of the magnetic layer 810 is defined to be able to obtain a greater than predetermined output at the time of reproduction. Usually, parameters representing the recording reproduction characteristic are reduced as the output increases, and it is therefore necessary to determine the optimum thickness.

The protective layer 84 may be a carbonaceous layer composed of carbon (C), hydrogenated carbon (H_{X}C), carbon nitride (CN), amorphous carbon and silicon carbide (SiC), or another usually employed protective layer material, such as SiO₂, Zr₂O₃ and TiN. The protective layer 84 may comprise two or more layers. The thickness of the protective layer 84 needs to be less than 10 nm. The reason is a thickness of the protective layer 84 greater than 10 nm is not preferred because the head and the magnetic recording layer 83 are away from each other, which may cause the input and output signal intensity to become insufficient.

Examples of the lubricant used for the lubricating film 85 include fluorine-based lubricant, hydrocarbon-based lubricant and mixtures thereof. The lubricating film 85 is usually formed to a thickness of 1 to 4 nm.

The magnetic recording medium produced by applying the invention is a “discrete magnetic recording medium” in which magnetic recording patterns 83a formed on the magnetic recording layer 83 are separated from one another by nonmagnetic areas 83b as illustrated, for example in FIG. 2.

The discrete magnetic recording medium may include a “patterned medium” in which the magnetic recording patterns 83a are arranged with certain regularly for every bit, a medium in which the magnetic recording patterns 83a are arranged in a track pattern and a medium in which the magnetic recording patterns 83a include a servo signal pattern.

Such a discrete magnetic recording medium can be obtained in the following manner: a mask layer is provided on a surface of the magnetic recording layer 83; and areas of the magnetic recording layer that are not covered with the mask layer are exposed to, for example, reactive plasma treatment or an ion irradiation treatment so that the magnetic recording layer 83 is partially reformed from a magnetic material to a nonmagnetic material to provide the nonmagnetic areas 83b.

The magnetic recording patterns 83a herein are sections which are separated by the nonmagnetic areas 83b that are obtained by partially reforming, desirably non-magnetizing, the magnetic recording layer 83 when seen the magnetic recording medium in a front surface side as illustrated in FIG. 2. It suffices that the magnetic layer 83 is isolated when seen from a surface side of the magnetic recording medium even if it is not isolated at the bottom of the magnetic layer 83 in order to achieve the object of the invention. That is also included in the scope of the magnetic recording pattern 83a of the invention.

The magnetic recording medium of the invention includes a patterned medium in which the magnetic recording patterns 83a are arranged with certain regularity for every bit, a medium in which the magnetic recording patterns 83a are arranged in a track pattern and a magnetic recording medium in which servo signal patterns or the like are arranged. As these, it is desirable from the viewpoint of simplicity in manufacture to apply the invention to the discrete magnetic recording medium in which the magnetic recording patterns 83a are the magnetic recording tracks and the servo signal patterns.

### (Magnetic Recording and Reproducing Apparatus)

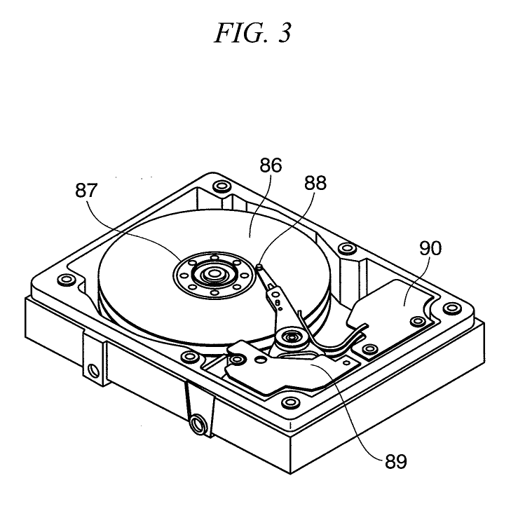

Examples of the magnetic recording and reproducing apparatus using the magnetic recording medium described above include a hard disk device as illustrated in FIG. 3. The hard disk device includes a magnetic disk 86 which is the magnetic recording medium described above, a medium driver 87 for rotatably driving the magnetic disk 86, a magnetic head 88 for recording data in or reproducing data from the magnetic disk 86, a head driver 89 and a recording and reproducing signal processing system 90. Then, magnetic reproducing signal processing system 90 processes input data, transmits recording signals to the magnetic head 88, processes the reproducing signal from the magnetic head 88 and outputs the processed data.

### (In-Line Film Formation Apparatus)

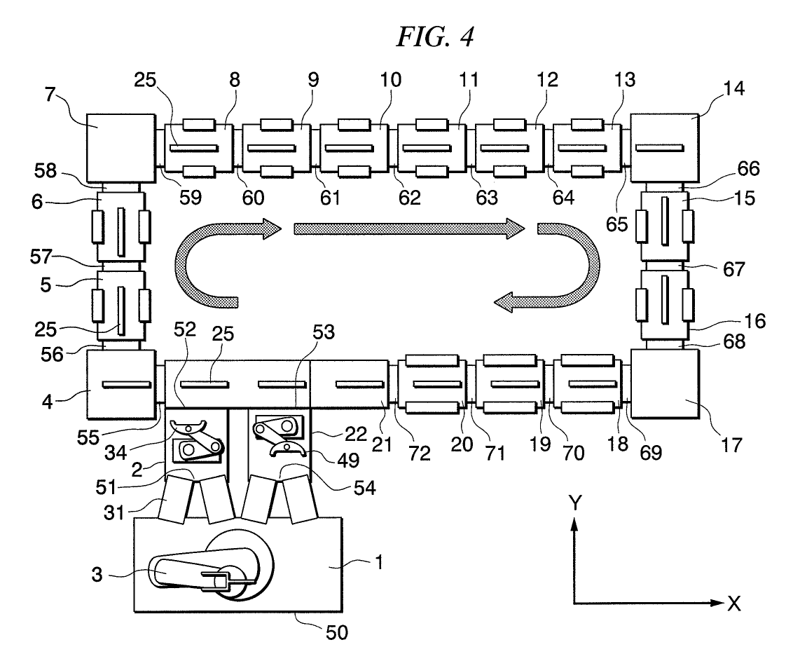

In producing a magnetic recording medium, a high-quality magnetic recording medium can be reliably obtained in a following manner: an in-line film formation apparatus (i.e., a producing apparatus of a magnetic recording medium) to which the invention is applied as illustrated, for example in FIGS. 4 to 7 is used; at least the soft magnetic layer 81, the intermediate layer 82, the magnetic recording layer 83 and the protective layer are laminated in this order on both sides of the nonmagnetic substrate 80 to be subject to film formation so as to form the magnetic layer 810 and to form the protective layer 84; further, a lubricant film 85 is formed on top of the protective layer 84.

Specifically, the in-line film formation apparatus includes a robot platform 1, a substrate cassette transfer robot 3 equipped on the robot platform 1, a substrate mounting robot chamber 2 adjacent to the robot chamber 1, a substrate mounting robot 34, a substrate mounting chamber 52, corner chambers 4, 7, 14 and 17, plural chambers 5, 6, 8 to 13, 15, 16, and 18 to 21, a substrate removal chamber 53, a substrate removing robot chamber 22 and a substrate removing robot 49. The substrate cassette transfer robot 3 is placed on the robot platform 1. The substrate mounting robot chamber 2 is disposed adjacent to the robot platform 1. The substrate mounting robot 34 is placed in the substrate mounting robot chamber 2. The substrate mounting chamber 52 is disposed adjacent to the substrate mounting robot chamber 2. The corner chambers 4, 7, 14 and 17 makes a carrier 25 rotate. Each of plural chambers 5, 6, 8 to 13, 15, 16, and 18 to 21 is disposed between the corner chambers 4, 7, 14 and 17. The substrate removal chamber 53 is disposed adjacent to the chamber 21. The substrate removing robot chamber 22 is disposed adjacent to the substrate removal chamber 53. The substrate removing robot 49 is placed inside the substrate removing robot chamber 22.

The substrate cassette transfer robot 3 supplies, to the substrate mounting chamber 2, the nonmagnetic substrate 80 from a cassette in which the nonmagnetic substrate 80 before film formation is housed, and takes out the nonmagnetic substrate 80 (i.e., the magnetic recording medium) after the film formation removed in the substrate removing robot chamber 22. Doors 51 and 54 each of which opens and closes an opening to the exterior is provided at a side wall of each of the substrate mounting robot chamber 2 and the substrate removing robot chamber 22.

Inside the substrate mounting chamber 52, the nonmagnetic substrate 80 before film formation is held on the carrier 25 using the substrate mounting robot 34. Inside the substrate removal chamber 53, the nonmagnetic substrate 80 (i.e., the magnetic recording medium) after film formation held on the carrier 25 is removed using the substrate removing robot 49.

Gate valves 55 to 72 are disposed at connecting sections of the chambers 2, 4 to 22, 52 and 53. When the gate valves 55 to 72 are in their closed states, each of the inside of the chambers 2, 4 to 22, 52, and 53 independently becomes enclosed space. Each of vacuum pumps (not illustrated) is connected to each of the chambers 2, 4 to 22, 52 and 53. The chambers can be decompressed by operations of the vacuum pumps. Each of the corner chambers 4, 7, 14 and 17 has a mechanism which rotates the carrier 25 and conveys it to a subsequent chamber in order to change the direction of movement of the carrier 25.

Among plural chambers 5, 6, 8 to 13, 15, 16 and 18 to 21, the chambers 6 and 8 constitutes a patterning chamber which has a mechanism for patterning the mask layer. The chambers 10, 11 and 12 constitute a working chamber which has a mechanism of partially reforming the magnetic recording layer 83 into a nonmagnetic material by having areas of the magnetic recording layer 83 that are not covered with the patterned mask layer subjected to a reactive plasma treatment or an ion irradiation treatment; or which has a mechanism of partially removing the magnetic recording layer 83 by etching so as to provide the magnetic recording patterns 83a composed of a remaining magnetic material. The chambers 16 and 18 constitute a removal chamber which has a mechanism of removing the mask layer. The chambers 19 and 20 constitute a protective layer forming chamber which has a mechanism of forming the protective layer 84 on the magnetic recording layer 83.

As described above, in the producing apparatus according to the present embodiment, the patterning chamber, the working chamber, the removal chamber and the protective layer forming chamber are constituted by the plural chambers 5, 6, 8 to 13, 15, 16, 18 to 21.

While sequentially conveying the carrier 25 by a conveyance mechanism described later, in each chamber 2, 4 to 22, 52 and 53 described above, both sides of the nonmagnetic substrate 80 held on the carrier 25 are subject to treatment. Finally, the magnetic recording medium illustrated in FIG. 2 is obtained.

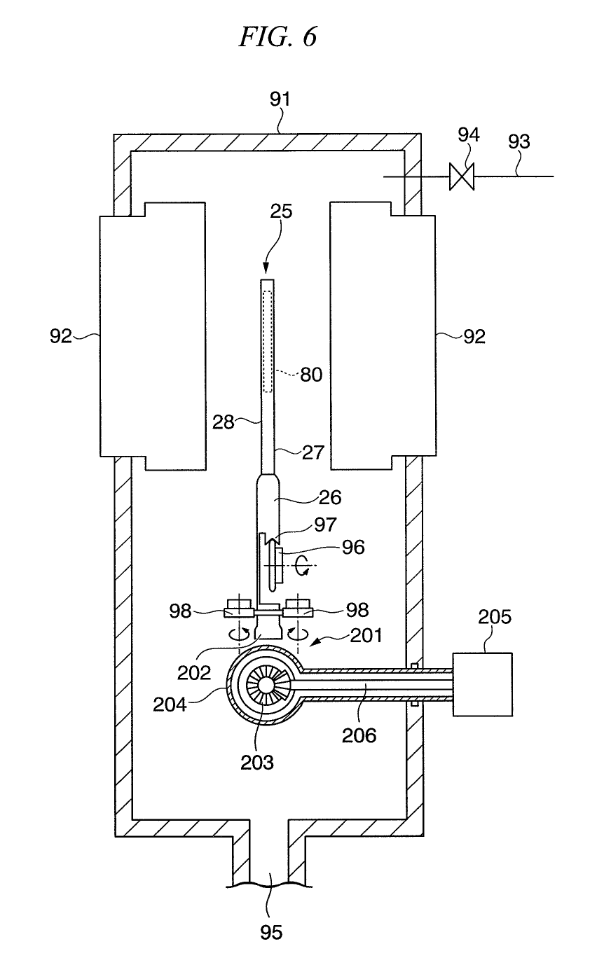

Constituents of the chambers 5, 6 and 8 to 13, 15, 16 and 18 to 21 for performing the processes for producing the magnetic recording medium are basically similar to one another except that constituents of the processing devices differ depending on the processes. Accordingly, the constituents of the chambers are described collectively with reference to a chamber 91 illustrated, for example in FIG. 6.

As illustrated in FIG. 6, the chamber 91 includes two processing devices 92 placed opposite each other with the carrier disposed therebetween. The processing devices 92 perform the film formation process to the nonmagnetic substrate 80 held on the carrier 25.

Two processing devices 92 may be cathode units which cause sputtering discharge if the film formation process is performed by sputtering, may be electrode units which form a film formation space for CVD method if the film formation process is performed by CVD method, and may be ion guns if the film formation process is performed by PVD method.

The chamber 91 also includes a gas introducing pipe 93 through which material gas and atmosphere gas are introduced inside the chamber 91. The gas introducing pipe 93 includes a valve 94 which is opened or closed by a control mechanism, which is not illustrated. When the valve 94 is opened or closed, gas supplied from the gas introducing pipe 93 is controlled.

The chamber 91 includes a gas exhausting pipe 95 connected to a vacuum pump (not illustrated). The chamber 91 can be evacuated inside under reduced pressure through the gas exhausting pipe 95 connected to the vacuum pump.

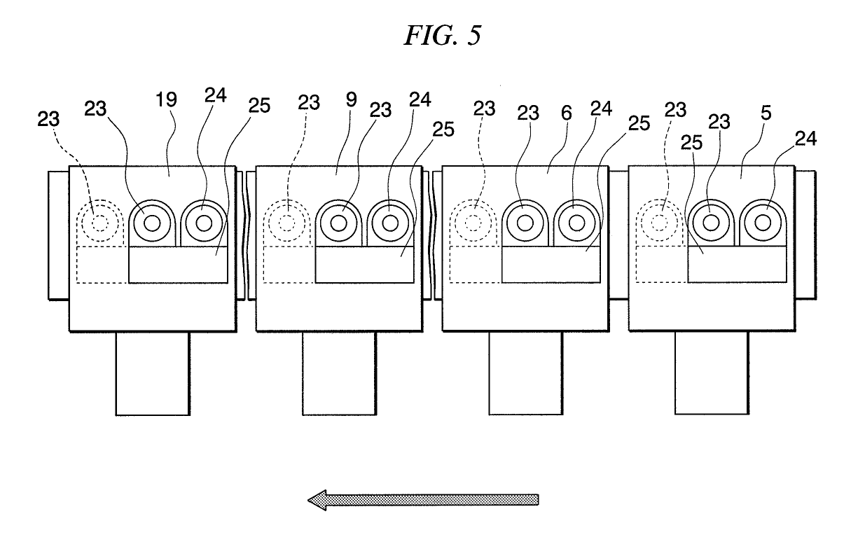

The carrier 25 includes a support platform 26 and plural holders 27 provided on an upper surface of the support platform 26, as illustrated in FIGS. 5, 6 and 7. Note that, since two holders 27 are provided in the present embodiment, two nonmagnetic substrates 80 held on these holders 27 are treated as a first substrate for film formation 23 and a second substrate for film formation 24.

In the present embodiment, for example, in a state in which the carrier 25 is stopped at a first processing position illustrated by a solid line in FIG. 5, the two processing devices 91 perform the film formation process to both sides of the first substrate for film formation 23 at the left side of the carrier 25. Then, the carrier 25 is moved to a second processing position illustrated by a dashed line in FIG. 5. In a state in which the carrier 25 is stopped in this position, the two processing devices 91 perform the film formation process to both sides of the second substrate for film formation 24 at the right side of the carrier 25.

Note that, if four processing devices 92 are placed at both sides of the carrier 25 opposite each of the first and second substrates 23 and 24 for film formation, movement of the carrier 25 is not necessary. In this case, the film formation process can be performed simultaneously to the first and second substrates 23 and 24 for film formation held on the carrier 25.

Two holders 27 are arranged in parallel and provided on the upper surface of the support platform 26 such that the first and second substrates 23 and 24 for film formation are kept in vertical positions (i.e., such that main surfaces of the substrates 23 and 24 are in parallel to the gravity direction). That is, the main surfaces of the first and second substrates 23 and 24 for film formation are substantially perpendicular to the upper surface of the support platform 26 and, at the same time, on substantially the same plane.

Each of the holders 27 includes a plate body 28 which has the same thickness or a thickness several times larger than those of the first and second substrates 23 and 24 for film formation and a circular opening 29 having a slightly larger diameter than outer peripheries of the first and second substrates 23 and 24 for film formation.

Plural support members 30 are attached to be elastically deformable around the opening 29 of each holder 27. Three support members 30 are arranged at certain intervals about the opening 29 of the holder 27 such that the outer peripheries of the outer peripheral sections of the first and second substrates 23 and 24 for film formation disposed inside the opening 29 are supported by three points: a lower side support point located at the lowermost position of the circumference; and a pair of upper side support points located in an upper side on the outer periphery that are symmetrical to a center line along the gravity direction passing the lower side support point.

With this configuration, the carrier 25 can hold the first and second substrates 23 and 24 for film formation, which are detachably fit in the support member 30, by the holder 27 while having the outer peripheral sections of the first and second substrates 23 and 24 for film formation abutted three support members 30. Attachment and detachment of the first and second substrates 23 and 24 for film formation with respect to the holder 27 are performed by the substrate mounting robot 34 or the substrate removing robot 49 which press the support members 30 downward at the lower side support point.

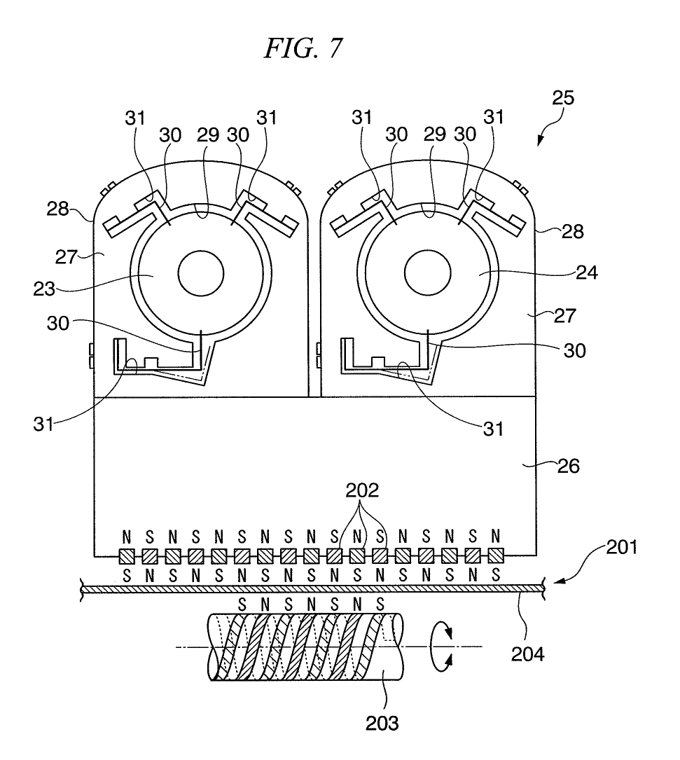

Each support member 30 is a spring member folded like an L-shape as illustrated in FIG. 7. A base end of each support member 30 is fixed to and supported by the holder 27. A distal end of each support member 30 is made to protrude toward the inside of the opening 29 and is disposed within a slit 31 formed in a periphery of the opening 29 of the holder 27. Although not illustrated, a V-shaped slot in which an outer peripheral section of each of the first and second substrates 23 and 24 for film formation is made to fit is provided at the distal end of the support member 30.

The in-line film formation apparatus includes a driving mechanism 201 which drives the carrier 25 in a noncontact manner as a conveyance mechanism of the carrier 25 as illustrated in FIGS. 6 and 7.

The driving mechanism 201 includes plural magnets 202 whose N-poles and S-poles are disposed alternately below the carrier 25. The driving mechanism 201 also includes a rotating magnet 203 disposed below the magnets 202 along the conveyance direction of the carrier 25. N-poles and S-poles are arranged alternately on an outer circumferential surface of the rotating magnet 203 as a double helix.

A vacuum partition 204 is disposed between the plural magnets 202 and the rotating magnet 203. The vacuum partition 204 is formed of a material of high magnetic permeability so that the plural magnets 202 and the rotating magnet 203 are magnetically coupled together. The vacuum partition 204 surrounds the circumference of the rotating magnet 203 so as to separate the inside of the chamber 91 from the ambient air.

The rotating magnet 203 is connected via plural gears which mesh with a rotation axis 206 driven by a rotary motor 205 to rotate. With this configuration, the rotating magnet 203 can be rotated about its axis while the driving force from the rotary motor 205 is transmitted to the rotating magnet 203 via the rotation axis 206.

The thus-configured driving mechanism 201 drives the carrier 25 linearly along the axial direction of the rotating magnet 203 by having the rotating magnet 203 rotated about its axis while having the magnets 202 at the side of the carrier 25 and the rotating magnet 203 magnetically coupled together in a non-contact manner.

In the chamber 91, plural main-bearings 96 supported rotatably about horizontal axes are disposed along the conveyance direction of the carrier 25 as a guide mechanism which guides the carrier 25 during conveyance. The carrier 25 includes a guide rail 97 in which the plural main-bearings 96 are engaged at a lower side of the support platform 26. A V-shaped slot is formed in the guide rail 97 along the longitudinal direction of the support platform 26.

In the chamber 91, a pair of sub-bearings 98 supported rotatably about vertical axes is arranged with the carrier 25 disposed therebetween. The pair of sub-bearings 98 is disposed along the conveyance direction of the carrier 25 like the plural main-bearings 96.

The main-bearings 96 and the sub-bearings 98 are bearings which reduce friction of machine parts and secure smooth rotational movement of the machine parts. In particular, the main-bearings 96 and the sub-bearings 98 are composed of rolling bearings which are rotatably mounted on a spindle (not illustrated in FIG. 6) fixed to a frame (i.e., a mounting member) provided in the chamber 91.

The carrier 25 is moved above the plural main-bearings 96 in a state in which the plural main-bearings 96 is engaged in the guide rail 97. The carrier 25 is disposed between the pair of sub-bearings 98 so that inclination thereof is prevented.

### (Method of Producing Magnetic Recording Medium)

In the method of producing the magnetic recording medium to which the invention is applied, for example, using the in-line film formation apparatus, the magnetic layer 810 constituted by the soft magnetic layer 81, the intermediate layer 82 and the magnetic recording layer 83 and the protective layer 84 are laminated in this order on both sides of the nonmagnetic substrate 80 while conveying sequentially the first or the second substrate 23 or 24 for film formation (i.e., the nonmagnetic substrate 80) held on the carrier 25 through plural chambers 5, 6, 8 to 13, 15, 16, 18 to 21.

In the working chambers 10, 11 and 12 in which the reactive plasma treatment or the ion irradiation treatment are performed after film formation of the magnetic recording layer 83, the magnetic recording layer 83 of the nonmagnetic substrate 80 held on the carrier 25 is subject to the reactive plasma treatment or the ion irradiation treatment to partially reform the magnetic recording layer 83 into a nonmagnetic material, or the magnetic recording layer 83 is partially removed by etching to form a magnetic recording pattern 83a composed of the remaining magnetic material. After the use of the in-line film formation apparatus, the lubricating film 85 is formed on the outermost surface of the magnetic recording medium using a coating device, which is not illustrated. In this manner, the magnetic recording medium illustrated in FIG. 2 is produced.

It is necessary in the invention to form a mask layer 840 on a surface of the magnetic layer 810 after the magnetic layer 810 is formed and to pattern the mask layer 840 by for example, nanoimprinting method or photolithography method. Since liquid resist should be employed when patterning the mask layer 840 by nanoimprinting method or photolithography method, it is difficult to perform these patterning processes in an in-line film formation apparatus.

To address this difficulty, it is desirable in the invention to take the processed substrate in which the magnetic layer 810 has been formed out of the in-line film formation apparatus. After the patterning of the mask layer or the resist layer, the processed substrate is then placed in the in-line film formation apparatus.

Before taking out the processed substrate in which the magnetic layer 810 has been formed out of the in-line film formation apparatus, it is preferred in the invention to form a continuous unpatterned mask layer by, for example, CVD method or sputtering method, on the surface of the magnetic layer 810, or to form a carbon protective film. This process prevents the surface of the magnetic layer 810 from being brought into direct contact with oxygen in the ambient air and thus prevents oxidization of the magnetic layer 810. As a result, a magnetic recording medium of high environmental resistance can be produced.

Patterning can be directly performed by photolithography method to the mask layer 840 or the carbon protective film formed in this process. However, a resist layer, which may be formed on the mask layer 840 or the carbon protective film, may be patterned, and then the magnetic recording medium may be placed in the in-line film formation apparatus of the invention. That is, the mask layer corresponding to the magnetic recording pattern 83a according to the invention includes a mask layer with a patterned resist layer formed on a surface thereof.

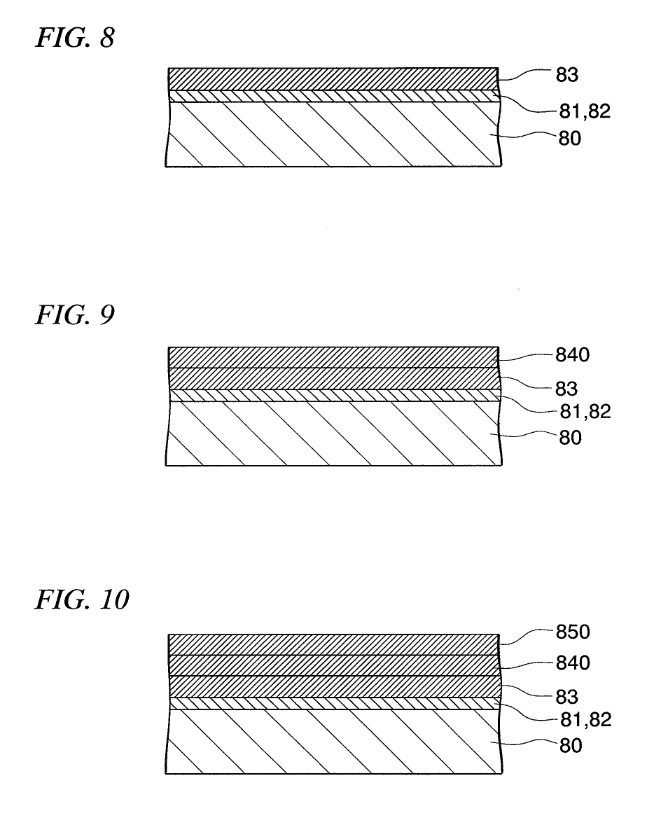

The method of producing the magnetic recording medium to which the invention is applied comprises the processes of: mounting the nonmagnetic substrate 80 on the carrier 25, the nonmagnetic substrate 80 having at least the magnetic recording layer 83 and the mask layer 840 corresponding to the magnetic recording pattern 83a laminated in this order as illustrated in FIGS. 8 to 16; forming the magnetic recording pattern 83a by having areas of the magnetic recording layer 83 that are not covered with the mask layer 840 subjected to a reactive plasma treatment or an ion irradiation treatment; removing the mask layer 840 from the magnetic recording layer 83; and removing the nonmagnetic substrate 80 from the carrier 25, wherein each of the chambers 5, 6, 8 to 13, 15, 16 and 18 to 21 has a decompressed atmosphere inside while the carrier 25 passes through each of the chambers 5, 6, 8 to 13, 15, 16 and 18 to 21 and each of the processes are conducted continuously while being blocked from the ambient air.

In particular, in the present embodiment, as illustrated in FIG. 8, the soft magnetic layer 81 and the intermediate layer 82 are laminated in this order on the nonmagnetic substrate 80, and then the magnetic recording layer 83 is formed by at least sputtering method.

Next, as illustrated in FIG. 9, the mask layer 840 is formed on the magnetic recording layer 83. Preferred examples of the material for the mask layer 840 include one or two or more selected from the group consisting of Ta, W, Ta nitride, W nitride, Si, SiO₂, Ta₂O₅, Re, Mo, Ti, V, Nb, Sn, Ga, Ge, As and Ni. Among these, As, Ge, Sn or Ga is preferably used, Ni, Ti, V or Nb is more preferably used and Mo, Ta or W is most preferably used.

Such a material increases shield ability of the mask layer 840 with respect to the milling ion and the recess 83c can be provided in the magnetic recording layer 83, which will be described later. The formation characteristic of the magnetic recording pattern 83a by the mask layer 840 can also be improved. Since the above-mentioned substances are easily dry-etched using reactive gas, in the removal process of the mask layer 840, which will be described later, an amount of the residue and thus contamination on the surface of the magnetic recording medium can be reduced.

Then, the processed substrate is taken out of the in-line film formation apparatus and the resist layer 850 is formed on the mask layer 840 as illustrated in FIG. 10. The resist layer 850 is preferably made of a radiation-curable material, which will be described later. Examples thereof include an ultraviolet curing resin, such as a novolak-based resin, acrylic ester resins and alicyclic epoxy resins.

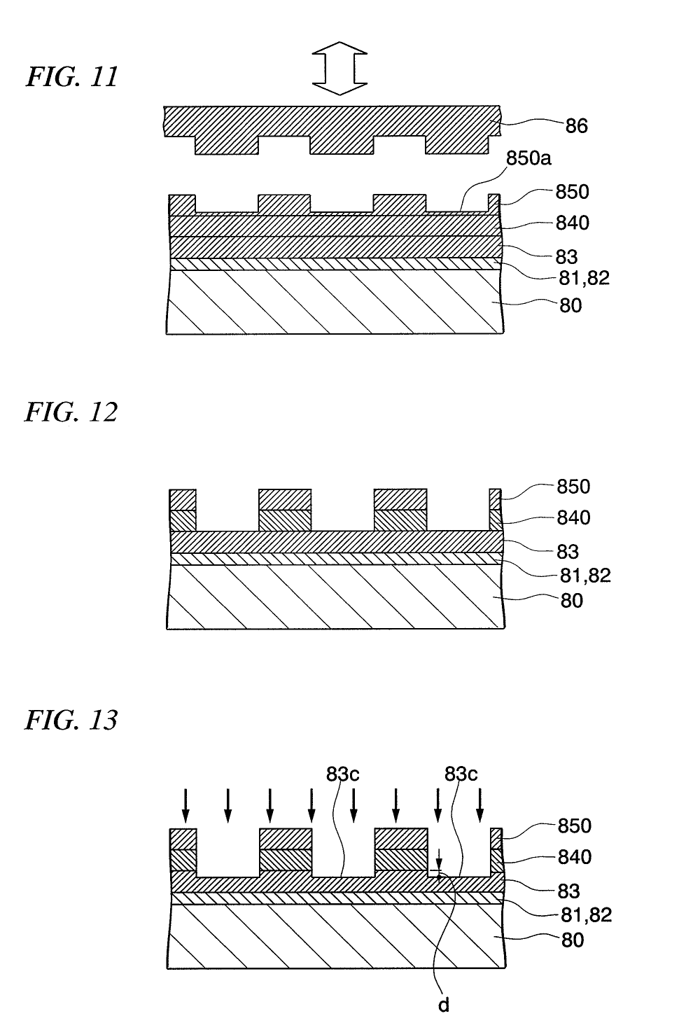

Next, as illustrated in FIG. 11, a negative pattern of the magnetic recording pattern 83a is transferred to the resist layer 850 using the stamp 86. An arrow in FIG. 11 represents movement of the stamp 86. It is preferred to employ glass or resin which is highly transmissive to the ultraviolet ray as a material of the stamp 86. The stamp 86 may be made of a material obtained by forming a fine track pattern on a metal plate by, for example, electron beam lithography. Examples thereof include Ni. The stamp 86 is not particularly limited so long as it has hardness and durability to withstand the above-described process.

During or after the process of transferring the pattern to the resist layer 850 using the stamp 86, the resist layer 850 is irradiated with radiation. Examples of the radiation used herein include a wide range of electromagnetic waves, such as heat ray, visible light, ultraviolet ray, X-ray and gamma ray. Examples of the radiation-curable material include heat-curing resin in case of the heat ray and ultraviolet curing resin in case of the ultraviolet ray.

Especially, in the process of transferring a pattern onto the resist layer 850 using the stamp 86, the stamp is pressed against the resist layer 850 in a state in which the mobility of the resist layer is high. With the stamp being pressed, the resist layer 850 is cured when irradiated with radiation. The stamp 86 is then removed from the resist layer 850. In this manner, the configuration of the stamp 86 can be transferred highly precisely to the resist layer 850.

Several methods are proposed to irradiate the resist layer 850 with radiation while the stamp 86 is pressed against the resist layer 850. For example, the resist layer 850 may be irradiated at an opposite side of the stamp 86, i.e., a side of a nonmagnetic substrate 80. The resist layer 850 may be irradiated at the side of the stamp 86 in a case in which the stamp 86 is made by a radiation-transmissive material. The resist layer 850 may be irradiated from a side surface of the stamp 86. The resist layer 850 may be irradiated by heat conduction of the stamp 86 or the nonmagnetic substrate 80 using highly conductive radiation with respect to a solid material, such as heat ray.

In this method, the configuration of the stamp 86 can be transferred with high accuracy to the resist layer 850, edge roll-off of the mask layer 840 can be eliminated, shield ability of the mask layer 840 with respect to the injected ion can be improved, and the formation characteristic of the magnetic recording pattern 83a by the mask layer 840 can be improved.

Thickness of the remainder 850a of the resist layer 850 after transferring the negative pattern to the resist layer 850 using the stamp 86 is preferably in a range of 0 to 10 nm. In this manner, in the patterning process using the mask layer 840 described later, edge roll-off of the mask layer 840 can be eliminated, shield ability of the mask layer 840 with respect to the injected ion can be improved and the recess 83c can be formed in the magnetic recording layer 83 with high accuracy. Formation characteristic of the magnetic recording pattern 83a using the mask layer 840 can be improved.

By using the stamp 86, in addition to the track pattern for recording usual data, servo signal patterns, such as a burst pattern, a gray code pattern and a preamble pattern, can also be formed.

Next, as illustrated in FIG. 12, the nonmagnetic substrate 80 processed so far is mounted on the carrier 25 in the substrate mounting chamber 52. Then, in the chambers 6 and 8 (i.e., the patterning chambers), the mask layer 840 is patterned using the resist layer 850 to which the negative pattern has been transferred, while sequentially conveying the nonmagnetic substrate 80 held on the carrier 25.

Next, as illustrated in FIG. 13, in the chamber 9, the recess 83c is formed by partially ion milling the surface of the magnetic recording layer 83 exposed through the patterning of the mask layer 840. Depth d of the recess 83c formed in the magnetic recording layer 83 is preferably in a range of 0.1 to 15 nm and more preferably in a range of 1 to 10 nm. If the removal depth by the ion milling is less than 0.1 nm, the effect of removal of the magnetic recording layer 83 mentioned above will not be exhibited. If the removal depth is greater than 15 nm, surface smoothness of the magnetic recording medium deteriorates and thus a surfacing property of the magnetic head deteriorates when producing of the magnetic recording and reproducing apparatus.

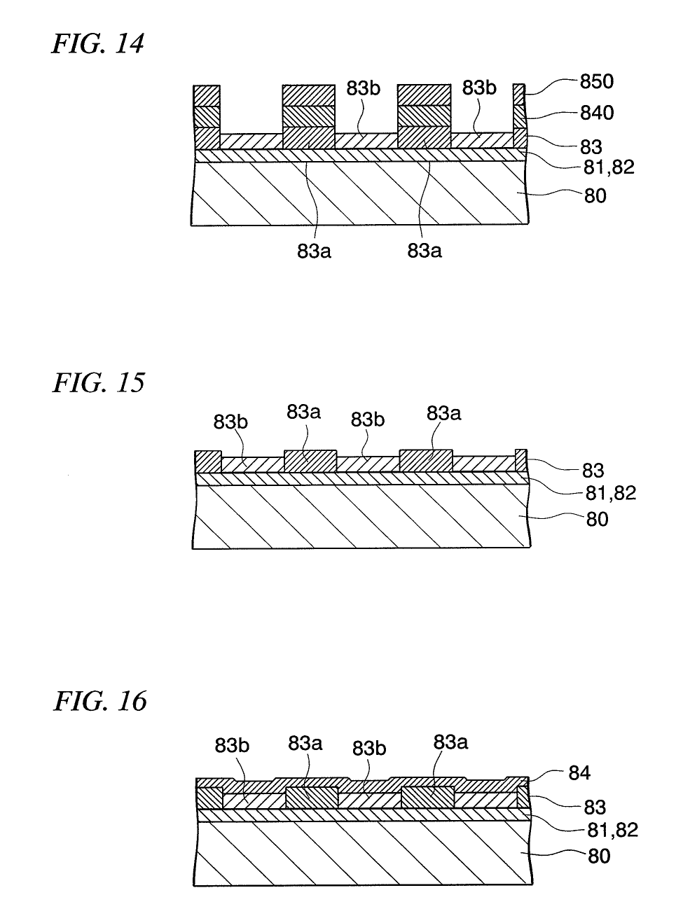

Next, as illustrated in the FIG. 14, in the chambers 10, 11 and 12 (i.e., the working chambers), areas of the magnetic recording layer 83 that are not covered with the mask layer 840 are subject to the reactive plasma treatment or the ion irradiation treatment to reform the magnetic material which constitutes the magnetic recording layer 83 into the nonmagnetic material. In this manner, the magnetic recording pattern 83a and the nonmagnetic area 83b are formed in the magnetic recording layer 83.

In the invention, it is preferred that after the recess 83c is provided, the surface of the magnetic recording layer 83 is exposed to the reactive plasma or the reactive ion to reform the magnetic property of the magnetic recording layer 83. As compared with a case where the recess 83c is not provided, pattern contrast of the magnetic recording pattern 83a and the nonmagnetic area 83b becomes clearer and thus S/N of the magnetic recording medium can be improved. This is because, since the surface section of the magnetic recording layer 83 is removed, the surface becomes clean and is activated and thus reactivity with the reactive plasma or the reactive ion is increased. Further, since defects, such as voids, are introduced in the surface section of the magnetic recording layer 83, the reactive ion easily invades into the magnetic recording layer 83 through the defects.

Examples of the reactive plasma include inductively coupled plasma (ICP) and reactive ion plasma (RIE). Examples of the reactive ion include the inductively coupled plasma mentioned above and reactive ion existing in the reactive ion plasma.

Examples of the inductively coupled plasma include high-temperature plasma obtained by applying high voltage to a gaseous material to generate the plasma and, further, applying a high-frequency varying magnetic field to generate Joule heat by an eddy current inside the plasma. The inductively coupled plasma has high electron density and thus enables reforming of the magnetic property at high efficiency in the magnetic film of large area compared with a case where the discrete track medium is produced using conventional ion beam.

Reactive ion plasma is the highly reactive plasma obtained by adding reactive gas, such as O₂, SF₆, CHF₃, CF₄ and CCl₄, to the plasma. Such plasma enables reformation of the magnetic property of the magnetic recording layer 83 at higher efficiency. In the invention, however, it is desirable that the plasma is halogen-free in order to improve the corrosion resistance of the magnetic recording medium.

Here, reformation of the magnetic recording layer 83 to form the magnetic recording pattern 83a refers to causing a partial change in, for example, coercive force and residual magnetization of the magnetic recording layer 83 in order to pattern the magnetic recording layer 83. The change refers to decrease in coercive force and in residual magnetization. Reformation of the magnetic property preferably is a reduction in the magnetization amount of the magnetic recording layer 83 in the areas exposed to the reactive plasma or the reactive ion to not greater than 75% and more preferably to not greater than 50% of that before the treatment, and a reduction in the coercive force to not greater than 50%, and more preferably to not greater than 20% of that before the treatment. With this configuration, bleeding during magnetic recording to the discrete magnetic recording medium produced according to the invention can be eliminated and thus high surface recording density can be obtained.

It is also possible in the invention to form areas (i.e., the nonmagnetic areas 83b) which isolate the magnetic recording track and the servo signal pattern section by exposing the already-film-formed magnetic recording layer 83 to the reactive plasma or the reactive ion so as to make the magnetic recording layer 83 amorphous. That is, reformation of the magnetic property of the magnetic recording layer 83 in the invention also includes reformation of the crystal structure of the magnetic recording layer 83.

Making the magnetic recording layer 83 amorphous in the invention refers to making the atomic arrangement of the magnetic recording layer 83 into an irregular atomic arrangement with no long range order, and in particular, randomly arranging microcrystal grains having diameters less than 2 nm. If the atomic arrangement state is confirmed by an analytical process, a state is obtained through X diffraction or electron diffraction in which no peaks representing crystal faces are recognized and only a halo is recognized.

The magnetic recording layer 83 is reformed by exposing the film formed magnetic recording layer 83 to the reactive plasma in the invention. The reformation is preferably performed by reaction of the magnetic metal which constitutes the magnetic recording layer 83 and atom or ions in the reactive plasma.

The term “reaction” used herein refers to, for example, change in the crystal structure of the magnetic metal caused by invasion of atoms in the reactive plasma into the magnetic metal, change in composition of the magnetic metal, and oxidation, nitridation and silication of the magnetic metal.

It is preferred to oxidize the magnetic recording layer 83 by adding the oxygen atom as the reactive plasma and causing a reaction between the magnetic metal which constitutes the magnetic recording layer 83 and the oxygen atom in reactive plasma. By partially oxidizing the magnetic recording layer 83, residual magnetization and coercive force of the oxidized section can be reduced efficiently. Accordingly, it becomes possible to produce the magnetic recording medium having a magnetic recording pattern through the short-time reactive plasma treatment.

Next, as illustrated in FIG. 15, the resist layer 850 is removed in the two chambers 13 and 15. Then the mask layer 840 is removed in the chambers 16 and 18 (i.e., the removal chambers). The resist layer 850 and the mask layer 840 can be removed by the method, for example, dry etching, reactive ion etching, ion milling and wet etching.

Next, as illustrated in FIG. 16, in the two chambers 19 and 20, the protective layer 84 is formed on the surface of the magnetic recording layer 83. Although the protective layer 84 is usually formed by forming a thin film of Diamond Like Carbon by, for example, P-CVD, the invention is not limited thereto. The protective film layer 84 may be a carbonaceous layer composed of carbon (C), hydrogenated carbon (HXC), carbon nitride (CN), amorphous carbon and silicon carbide (SiC), or another usually employed protective layer material, such as SiO₂, Zr₂O₃ and TiN. The protective layer 84 may include two or more layers.

The thickness of the protective layer 84 is preferably not greater than 10 nm. The thickness of the protective layer 84 greater than 10 nm is not preferred that the head and the magnetic recording layer 83 are separated from each other, which may cause the input and output signal intensity to become insufficient.

After the use of the in-line film formation apparatus, the lubricating film 85 is formed on an outermost surface of the magnetic recording medium using a coating device, which is not illustrated. Examples of the lubricant used for the lubricating layer 85 include fluorine-based lubricant, hydrocarbon-based lubricant and mixtures thereof. Thickness of the lubricating layer 85 is typically 1 to 4 nm. These processes can provide the magnetic recording medium illustrated in FIG. 2.

In the method of producing the magnetic recording medium to which the invention is applied, each of the chambers 5, 6, 8 to 13, 15, 16 and 18 to 21 has a decompressed atmosphere inside while the carrier 25 which holds the nonmagnetic substrate 80 passes through each of the chambers 5, 6, 8 to 13, 15, 16 and 18 to 21 and each of the processes are conducted continuously while being blocked from the ambient air.

Accordingly, the nonmagnetic substrate is not exposed to the ambient air even if the areas of the magnetic recording layer formed on the nonmagnetic substrate that are not covered with the mask layer are subjected to the reactive plasma treatment or the ion irradiation treatment and the mask layer is removed from on the magnetic recording layer after the formation of the magnetic recording pattern. It is therefore possible to prevent oxidization of the activated surface of the magnetic recording layer 83. As a result, a discrete magnetic recording medium with environmental resistance, especially corrosion resistance, equivalent to that of the magnetic recording medium having unpatterned magnetic recording layer 83 illustrated in FIG. 1 can be obtained.

Especially if dry etching using halogen is performed in the process described above, a halide, such as a cobalt halide, is formed on the activated surface of the magnetic recording layer and when the halide is brought into contact with the ambient air, the halide may cause rapid corrosion of the magnetic recording medium. According to the invention, the discrete magnetic recording medium with further improved environmental resistance can be obtained by conducting the above-described processes under a halogen gas-free environment.

If the discrete magnetic recording medium is used for the hard disk device illustrated in FIG. 3, it is possible to provide a hard disk device that can be reliably used in even in high-temperature environments, such as car compartments.

According to the invention, since the processes from the reformation of the magnetic recording layer 83 to the formation of the protective layer 84 can be continuously performed in a single in-line film formation apparatus, the contamination of the nonmagnetic substrate 80 during producing the magnetic recording medium can be prevented, the producing process can be made efficient with fewer handling processes and the product yield can be increased to improve productivity of the magnetic recording medium.

According to the invention, since the process of exposing the areas of the magnetic recording layer 83 that are not covered with the mask layer 840 to, for example, the reactive plasma to reform the magnetic property of these areas and the process of removing the mask layer are conducted separately in plural chambers, and such a method can be easily applied to the in-line film formation apparatus described above.

According to the invention, the film formation process of, for example, the magnetic recording layer 83 can be processed in about 10 seconds for each substrate. Since it is difficult, however, to complete the process of partially reforming the magnetic property of the magnetic recording layer 83 and the process of removing the mask layer 340 in that time, the reforming process and the removal process are conducted separately in the plural chambers so that the processing time of these processes can be synchronized with that of the film formation process of, for example, the magnetic recording layer 83, and thereby each process can be conducted continuously.

In particular, among the processes of the present embodiment, the processes of mounting and removing the nonmagnetic substrate 80 can be conducted at a processing time at about one second for each substrate, but the reforming process and the removal process require approximately tens of seconds, and the protective layer forming process requires the processing time of from several seconds to about 30 seconds. In order to conduct each of the processes in a single respective chamber, the reforming process and the removal process become a rate-limiting factor and it is therefore necessary to synchronize other processes with the reforming process and the removal process.

On the contrary, in the invention, among the processes from the reforming process to the protective layer forming process, the processes whose processing speed becomes the rate-limiting factor are conducted in plural chambers. Thus, the processing time among the processes can be made as equivalent as possible and thus productivity of the magnetic recording medium can be improved. For example, if the processing time of the processes of mounting and removing each substrate in a single chamber is one second, the processing time of the reforming process and the removal process is 60 seconds and the processing time of the protective layer forming process is 30 seconds, the total processing time in a case the where each process is conducted in a single chamber is 60 seconds for each substrate. Here, as in the invention, if two chambers are prepared for each of the reforming process and the removal process, the processing time per substrate can be reduced by 30 seconds. If four chambers are prepared for each of the reforming process and the removal process and two chambers are prepared for the protective layer forming process, the processing time per substrate can be reduced by 15 seconds.

According to the invention, the process of patterning the mask layer 840 formed on the magnetic recording layer 83 includes a wet process in which liquid resist is applied to the surface of the magnetic recording layer 83 and a mold is stamped on the surface so as to transfer a mold pattern. In the invention, however, since all the processes except for the application of the resist are dry processes, these processes can be conducted continuously in a single producing apparatus along with the sputtering process, which is also the dry process, of the magnetic recording layer 83.

It should be noted that the invention is not limited to embodiments described above but can be modified without departing from the spirit and scope of the invention. For example, although the magnetic recording layer 83 is partially reformed into the nonmagnetic material in the process illustrated in FIG. 14, the magnetic recording pattern 83a composed of the remaining magnetic material may alternatively be formed by partially removing the magnetic recording layer 83 by etching. In this case, the areas from which the magnetic recording layer 83 was partially removed were filled with the nonmagnetic material. In this manner, a magnetic recording pattern 83a and a nonmagnetic area 83b are formed in the magnetic recording layer 83.

The process of forming the protective layer 84 is not necessarily included in the invention. Accordingly, in the in-line film formation apparatus illustrated in FIG. 4, it is also possible to omit the chambers (i.e., the protective layer forming chamber) 19 and 20 together with the protective layer forming process.

Since the magnetic recording medium usually includes the magnetic recording layer 83 at both surfaces thereof, it is desirable in the invention that both sides of the nonmagnetic substrate 80 are subject to the reactive plasma treatment or the reactive ion treatment at the same time. However, these treatments may alternatively be conducted on one surface at a time.

Hereinafter, the advantageous effects of the invention will be described in more detail with reference to Examples. It should be noted that the invention is not limited to these Examples and can be modified without departing from the spirit and scope of the invention.

### Example 1

In Example 1, a glass substrate for the HD was prepared first as a nonmagnetic substrate and placed in a vacuum chamber of an in-line film formation apparatus. The vacuum chamber was evacuated to less than 1.0×10⁻⁵ Pa in advance. The glass substrate used herein was crystallized glass constituted by Li₂Si₂O₅, Al₂O₃—K₂O, Al₂O₃—K₂O, MgO—P₂O₅ and Sb₂O₃—ZnO. The glass substrate was formed such that the outer diameter was 65 mm, the inner diameter was 20 mm and the average surface roughness (Ra) was 2 \acute{Å}.

The magnetic layer was formed on the both sides of the glass substrate by laminating FeCoB as the soft magnetic layer, Ru as the intermediate layer and a 70Co-5Cr-15Pt-10SiO₂ alloy as the magnetic recording layer by DC sputtering method. The thickness of the soft magnetic layer was 600 \acute{Å}, the thickness of the intermediate layer was 100 \acute{Å} and the thickness of the magnetic recording layer was 150 \acute{Å}.

Next, the mask layer was formed on the magnetic layer by sputtering method. The mask layer was constituted by Ta and the thickness thereof was 60 nm. Then, the glass substrate with the mask layer formed thereon was taken out from the in-line film formation apparatus. Resist was applied onto the mask layer to form a resist layer by spin coat method. Novolak-based resin which was the ultraviolet curing resin was used as the resist. The thickness of the resist layer was 100 nm.

Next, a glass stamp having a negative pattern of the magnetic recording pattern was prepared, which was then pressed against the resist layer at the pressure of 1 MPa (about 8.8 kgf/cm²). In this state, the resist layer was irradiated with a UV ray having a wavelength of 250 nm for 10 seconds from above the glass stamp having a UV transmittance of not less than 95% so as to cure the resist layer. Then, the uneven pattern corresponding to the magnetic recording pattern was transferred to the resist layer by isolating the stamp from the resist layer.

The uneven patterns transferred to the resist layer had circumferential projections of 120 nm in diameter and circumferential recesses 60 nm in diameter. The thickness of the cured resist layer was 80 nm and the thickness of the remainder constituting the recess of the resist layer was about 5 nm. The side wall surface which constitutes the recess of the resist layer was angled by about 90 degrees with respect to the substrate surface.

The thus-produced processed substrate was placed in the in-line film formation apparatus according to the invention illustrated in FIG. 4. In this apparatus, the process of mounting the processed substrate on the carrier 25 was performed in a single substrate mounting chamber 52, the process of removing the remainder of the recess of the resist layer was performed in the single processing chamber 5, the process of patterning the mask layer in the processing chambers 6 and 8 (i.e., the patterning chambers) and the process of partially removing the surface of the magnetic recording layer was performed in the single processing chamber 9.

In this apparatus, the process of partially reforming the magnetic recording layer was performed in the processing chambers 10, 11 and 12 (i.e., the reforming chambers), the process of removing the resist was performed in the chambers 13 and 15, the process of removing the mask layer was performed in the processing chambers 16 and 18 (i.e., the removal chambers) and the process of film formation of the carbon protective layer was performed in the processing chambers 19 and 20 (i.e., the protective layer forming chambers). In this apparatus, the process of removing the processed substrate from the carrier 25 was performed in the single substrate removal chamber 53. The processing time in each chamber was not longer than 15 seconds.

In particular, the processing conditions were as follows: in the removal process of the recess of the resist layer, the carrier 25 having the processed substrate mounted thereon was rotated in the corner chamber 4. The carrier 25 is then moved to the processing chamber 5 where the part of the recess of the resist layer was removed by dry etching. The conditions for dry etching were the use of an O₂ gas at 40 sccm, a pressure of 0.3 Pa, a high-frequency plasma power of 300 W, a DC bias of 30 W, and an etching time of 15 seconds.

Next, in the patterning process of the mask layer, the processed substrate which had been subject to etching was transported to the two processing chambers 6 and 8 for patterning of the mask layer. The areas which were not covered with the resist on the mask layer of the Ta in the processing chambers 6 and 8 were removed through dry etching. The conditions for dry etching of the resist layer were the use of an O₂ gas at 40 sccm, a pressure of 0.3 Pa, a high-frequency plasma power of 300 W, a DC bias of 30 W, and an etching time of 10 seconds. The conditions for dry etching of the mask layer were the use of an O₂ gas at 50 sccm, a pressure of 0.6 Pa, a high-frequency plasma power of 500 W, a DC bias of 60 W, and an etching time of 15 seconds for each chamber. The total etching time was 30 seconds.

Next, in the process of partially removing the surface of the magnetic recording layer, the dry-etched processed substrate was moved to the processing chamber 9 where the magnetic recording layer was partially removed. In the processing chamber 9, areas of the surface of the magnetic recording layer that were not covered with the mask layer were removed by ion milling. The conditions of the ion milling were as follows: Ar ions were used; the amount of ions was 5×10¹⁶ atoms/cm², the accelerating voltage of an ion source and a ring member was 20 keV, the milling depth of the magnetic recording layer was 0.1 nm and the duration was 5 seconds.

Next, in the process of partially reforming the magnetic recording layer, the processed substrate which had been subject to ion milling was moved to the processing chambers 10, 11 and 12 in which the magnetic recording layer was partially reformed. In the processing chambers 10, 11 and 12, areas of the surface of the magnetic recording layer that were not covered with the mask layer were exposed to reactive plasma so as to reform the magnetic property of the magnetic recording layer. An inductively coupled plasma device available from ULVAC, Inc. was used in the reactive plasma treatment of the magnetic recording layer. The plasma-generating gas and the conditions were as follows: used gas was O₂ (90 cc/min); supplied power for plasma generation was 200 W, the pressure in the chamber was 0.5 Pa; and the processing time of the magnetic layer in each chamber was 15 seconds and for a total processing time of 45 seconds.

Next, in the process of removing the resist layer, the processed substrate which had been subject to the reforming treatment was transported to the two processing chambers 13 and 15 where the resist layer was removed. In the processing chambers 13 and 15, the resist layer was removed through dry etching. The conditions for dry etching were the use of an O₂ gas at 40 sccm, a pressure of 0.3 Pa, a high-frequency plasma power of 300 W, a DC bias of 30 W, and an etching time of 15 seconds.

Next, in the process of removing the mask layer, the processed substrate from which the resist layer was removed was moved to the processing chambers 16 and 18 where the mask layer was removed. In the processing chambers 16 and 18, the mask layer was removed by dry etching. The conditions for dry etching of the resist layer were the use of an O₂ gas at 40 sccm, a pressure of 0.3 Pa, a high-frequency plasma power of 300 W, a DC bias of 30 W, and an etching time of 10 seconds. The conditions for dry etching of the Ta layer were the use of an O₂ gas at 50 sccm, a pressure of 0.6 Pa, a high-frequency plasma power of 500 W, a DC bias of 60 W, and an etching time of 15 seconds in each chamber for a total etching time of 30 seconds.

Next, in the forming process of the carbon protective layer, the processed substrate from which the mask layer had been removed was moved to the processing chambers 19 and 20 in this order, where 5 nm of the carbon protective layer was formed by CVD method on the magnetic layer. The film formation time was 15 seconds.

Next, in the process of removing the processed substrate from the carrier 25, the processed substrate after the film formation was moved to the substrate removal chamber 53 in which the processed substrate was removed from the carrier 25. The processed substrate was removed from the carrier 25 at a speed of 1.5 seconds/sheet in the substrate removal chamber 53.

### Comparative Example 1

In Comparative Example 1, the magnetic recording medium was produced in the same manner as in Example 1 except that the nonmagnetic substrate was exposed to the ambient air for 10 seconds under pressure of 10 Pa between the process of partially removing the magnetic recording layer surface of Example 1 and the process of partially reforming the magnetic recording layer, i.e., between the processing chamber 9 and the processing chamber 10, in order to confirm the advantageous effect of the invention.

### Example 2

In Example 2, a magnetic recording medium was produced in the same manner as in Example 1 except that CF₄ gas was used instead of an O₂ gas for etching the Ta layer in the processing chambers 16 and 18.

### (Evaluation of Corrosion Resistance)

Corrosion resistance was evaluated for the magnetic recording media of Examples 1 and 2 and Comparative Example 1. For the evaluation, all of the magnetic recording media was kept in an ambient air environment with a temperature of 80° C. and a humidity of 85% for 96 hours. The number of the corrosion spots having a diameter larger than 5 microns φ developed on the surface of the magnetic recording medium was counted.

A 3% nitric acid solution was dropped at five points (i.e., 100 microliters/point) and pure water are dropped at five points (i.e., 100 microliters/point) on the surface of each of the magnetic recording media. The magnetic recording medium was left for one hour and then collected. The amount of Co contained was measured by the ICP-MS. In the measurement by the ICP-MS, 1 ml of 3% nitric acid solution containing 200 ppt of Y was used as a reference solution.

The following evaluation results were obtained.

### (Number of Corrosion Spot)

Example 1: 0/face

Comparative Example 1: 82/face

Example 2: 67/face

### (Amount of Extracted Cobalt)

Example 1: 0.05 micrograms/face

Comparative Example 1: 10.02 micrograms/face

Example 2: 7.82 micrograms/face

As described above, according to the invention, a large part of the processes in producing a discrete magnetic recording medium can be conducted in an in-line film formation apparatus which is blocked from the ambient air and is under a decompressed atmosphere. It is therefore possible to produce a highly corrosion-resistant magnetic recording medium with high productivity since the nonmagnetic substrate is not exposed to the ambient air, surfaces of the magnetic recording layer or other layers that are activated are not oxidized when exposed to the ambient air and contact with halogens can be strictly controlled. While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A method of producing a magnetic recording medium which has a magnetic recording pattern on a magnetic recording layer formed at least on a surface of a nonmagnetic substrate by using an in-line film formation apparatus that includes a plurality of chambers, a carrier which holds a nonmagnetic substrate through the plurality of chambers and a conveyance mechanism which conveys the carrier sequentially among the plurality of chambers, which comprises the steps of:
mounting a nonmagnetic substrate on the carrier, the nonmagnetic substrate having at least the magnetic recording layer and a mask layer corresponding to the magnetic recording pattern laminated thereon in this order;
forming the magnetic recording pattern by having areas of the magnetic recording layer that are not covered with the mask layer subjected to a reactive plasma treatment or an ion irradiation treatment;
removing the mask layer from the magnetic recording layer; and
removing the nonmagnetic substrate from the carrier,
wherein each of the chambers has a decompressed atmosphere inside while the carrier passes through each of the chambers and each of the processes are conducted continuously while being blocked from the ambient air.

2. The method of producing a magnetic recording medium according to claim 1, wherein each of the processes is conducted under a halogen gas-free atmosphere.

3. An apparatus for producing a magnetic recording medium, which comprises: a plurality of chambers; a carrier which holds a nonmagnetic substrate through the plurality of chambers; and a conveyance mechanism which conveys the carrier sequentially among the plurality of chambers, the apparatus being used to produce a magnetic recording medium which has a magnetic recording pattern on a magnetic recording layer formed at least on a surface of a nonmagnetic substrate,
wherein the plurality of chambers include:
a chamber equipped with a substrate mounting mechanism which mounts a nonmagnetic substrate on the carrier, the nonmagnetic substrate having at least the magnetic recording layer and a mask layer corresponding to the magnetic recording pattern laminated thereon in this order;
a chamber in which the magnetic recording pattern is formed by having areas of the magnetic recording layer that are not covered with the mask layer subjected to a reactive plasma treatment or an ion irradiation treatment;
a chamber in which the mask layer is removed from the magnetic recording layer; and
a chamber equipped with a substrate removal mechanism which removes the nonmagnetic substrate from the carrier,
wherein each of the chambers has a decompressed atmosphere inside while the carrier passes through each of the chambers and is blocked from the ambient air.
